(19) United States
(12) Patent Application Publication
(10) Pub. No.: US 2015/0149273 A1
(43) Pub. Date: May 28, 2015

(54) METHOD, SERVER AND COMPUTER PROGRAM TO OPTIMIZE ONLINE ADVERTISING

(71) Applicant: HURRA Communications GmbH, Stuttgart (DE)

(72) Inventor: Rene Schweier, Stuttgart (DE)

(21) Appl. No.: 14/332,447

(22) Filed: Jul. 16, 2014

(30) Foreign Application Priority Data
Jul. 16, 2013 (EP) 13 176 739.4
Aug. 1, 2013 (EP) 13 178 957.0

(51) Int. Cl. G06Q 30/02

(52) U.S. Cl. CPC G06Q 30/0244; G06Q 30/0264
USPC 705/14.43

(57) ABSTRACT

A method, a server, and a computer program for optimizing online advertisement that is booked via a communication network in a system for realtime booking of online advertisement in the communication network on a particular network page, at a particular time, in association with a particular search term, and/or as a particular type of online advertisement. In order to increase the relevance of the online advertisement to a user of a client of the communication network, a server that is connected to the communication network automatically scans a broadcast radio program running on at least one station, the server automatically evaluates the broadcast radio program for the purpose of recognizing the content, and the server optimizes the online advertisement according to a particular algorithm on the basis of the result of the evaluation of the broadcast radio program.

### CROSS-REFERENCE TO RELATED APPLICATION

This application is based upon and claims priority to: European Patent Application No. 13176739.4 filed on Jul. 16, 2013, and European Patent Application No. 13178957.0 filed on Aug. 1, 2013.

### BACKGROUND OF THE INVENTION

1. Field of the Invention

The present invention relates, generally, to online advertising and, more specifically, to a method, server and computer program to optimize online advertising.

2. Description of the Related Art

Online advertising is known in the art and generally involves a method, server, and computer program. The method is used for optimizing online advertisement that is booked via a communication network in a system for realtime booking of online advertisement in the communication network on a particular network page, at a particular time, in association with a particular search term, and/or as a particular type of online advertisement. The server is connected to a communication network so as to optimize online advertisement. The server is used for booking online advertisement in the communication network on a particular network page, at a particular time, in association with a particular search term, and/or as a particular type of online advertisement via the communication network in a system for realtime booking of online advertisement. The computer program runs on a microprocessor of a server connected to a communication network, and is programmed to optimize online advertisement. The online advertisement is booked via the communication network in a system for realtime booking of online advertisement in the communication network on a particular network page, at a particular time, in association with a particular search term and/or as a particular type of online advertisement.

A method, a server, and a computer program of the type described above are known, for example, from U.S. Pat. No. 8,301,747, which teaches a communication network used to present a particular online advertisement on a particular network page to a multiplicity of online users on the clients thereof. In particular, it is proposed that the online advertisement is optimized on the basis of the reaction of the online users to the online advertisement, where online advertisement that leads to high turnovers of the advertised product or in the advertised online shop is rated as successful, and where online advertisement that does not lead to higher turnovers of the advertised product or in the advertised online shop is regarded as less successful. By way of example, the less successful online advertisement can be optimized by either modifying it in future or no longer presenting it on the previous network page. One modification of the online advertisement may include presentation on another network page, a change in the type of online advertisement, a change in the content and/or in the appearance of the online advertisement, among other things.

The goal when optimizing online advertisement is usually to make the most efficient use of an available budget for the online advertisement. To that end, it is not simply possible to reduce the expenditure for placing online advertisement on a network page in blanket fashion, which could sometimes lead to poorer positioning of the online advertisement on the network page, as a result of which the success of the online advertisement could be reduced. Thus, the price paid for a decrease in the expenditure for the online advertisement would be poorer efficiency of the online advertisement. However, the expenditure for placing online advertisement on a network page cannot be increased in blanket fashion, since the limited budget necessitates that only less online advertisement could be placed.

By way of example, a server denotes a computer that is connected to a communication network, for example the Internet, and on which a piece of software runs, as a result of which the server is suitable for providing particular services, such as the provision of information or resources (for example memory space, computation capacity, or access to a communication network). The services are typically used by what is known as a client. To this end, the client uses a communication network, for example the Internet, to place a query with the server. The server evaluates the incoming query, may check an authorization for the client to place the query, and transmits information corresponding to the query or makes requested resources available. Frequently, information is made available to a client by a server in the form of what are known as network pages (also called Internet pages or “pages” for short).

The content of a network page is described by using a page description language. The standardized page description language HTML (Hyper Text Markup Language) is predominantly used for this purpose. HTML allows the content and appearance of a network page to be easily described in what is known as an HTML document. If a client requests information from a server, for example, the server transmits an HTML document containing the requested information to the client. If the information transmitted to the client by the HTML document is intended to be presented to a user, the network page or the HTML document is supplied to a specific computer program (what is referred to as a “browser”) that is capable of interpreting HTML documents and of using a graphical interface to present them on a computer monitor.

The network pages transmitted from the server to the client may already have been produced and stored at a suitable location before the request by the client. Such network pages are referred to as static network pages. Frequently, however, a client places a query with the server that is so specific that network pages containing the requested information are produced dynamically by the server. This is the case when a user uses the client to send a query in the form of a search term to a server in the form of a search engine, for example. The search engine uses the search term according to a prescribable algorithm to ascertain information that is associated with the search term. On the basis of the ascertained information, a dynamic network page is automatically produced by the server and transmitted to the client.

A multiplicity of clients and servers communicate via the Internet and together form a multimedia information system, what is known as the WWW (World Wide Web). Network pages made available within the WWW can be addressed via a URL (Uniform Resource Locator). A URL is made up from the name of the server making the network page available, a directory, and a name associated with the network page, among other things. A URL allows the network page associated with this URL to be dialed in directly from a client. To this end, a user uses a keyboard, for example, to input the URL in a specific input field of the browser. The client then generates and transmits a query via the Internet to the relevant server, which then transmits the requested network page via the Internet to the client.

Within an HTML document, it is possible to specify URLs of further network pages or HTML documents. Such URLs are called a reference or hyperlink (link, for short). References presented on static network pages are called static references. Similarly, references presented on dynamic network pages are called dynamic references.

When references are presented to a user via a browser, the user has the opportunity to dial in a presented reference and display the network page corresponding to the dialed-in URL. In this case, the dialed-in network page may also be located on a different server, in particular.

Frequently, a first server assigns a second server to present online advertisement on network pages that are transmitted by the second server. The online advertisement may include a reference to a network page on the first server. Such a reference may be what is known as an advertising banner, for example, which uses a textual and/or graphical representation to advertise for a product that can be obtained by the first server or a service that is conveyed via the first server. In this case, the assignment of the second server by the first server can be effected either directly or indirectly via a service provider or a further server associated with the service provider. The first server may be associated with an online shop, for example, that provides the product advertised via the online advertisement or the advertised service. The second server may be associated with a search engine provider, for example, that presents a hits list with search hits for a particular search query and additionally selected online advertisement on a network page. The service provider with which the further server is associated may be a company for optimizing online marketing, for example.

Online advertisement that is presented on the second network page typically has associated text, sound and/or graphic elements that are presented to a user who has requested the second network page, for example via a search query to a search engine operator, via the browser. The term “online advertisement” therefore also includes all of the information associated with the online advertisement.

A product may also be a piece of information provided by the first server, in particular. In addition, a product may be access afforded by the first server to a protected memory area in which further information is stored and can be retrieved. Such information may be news, stock prices and also other text, music or image files, for example.

Frequently, the information transmitted from the second server to the client is distributed over a plurality of network pages, with initially only one network page being transmitted to the client. The client then progressively requests one of the further network pages from the second server.

If the second server is a search engine, the first server can assign the second server to present online advertisement on a network page that is produced on the basis of search term that is input by a user. The assignment is usually effected online and in real time by the communication network. Frequently, positions for online advertisement on the network page of the second server are auctioned. To this end, the first server sends a maximum bid and is then allocated, taking account of the other bids, an appropriate position on the network page on which the online advertisement is presented.

In practice, the sequence of this is then, by way of example, such that a user of a client transmits a search query based on a particular search term to the second server by the communication network. The second server for its part creates the corresponding hits list as a dynamic network page. Apart from the hits, a particular number of positions for online advertisement are also available on the network page. These positions are then auctioned in real time or more or less in real time as part of an online auction. This takes account of bids that are present on the second server for the search term requested by the user. The highest bid is usually provided with the best or most desirable position on the network page made available by the second server. As the level of the bids decreases, the less desirable positions are then allocated. It may even occur that low bids are unable to purchase a position on the network page in the auction. Finally, the dynamically generated network page with the hits list and with the online advertisement at the positions purchased in the auction is transmitted via the communication network to the client and presented there on the browser.

The more online advertisement is presented on a network page transmitted from a second server to a client, the greater, usually, the volume of data on the network page that is to be transmitted. This results in increased loading for the communication network. This is intensified further if, on account of the large number of instances of online advertisement, a plurality of network pages are transmitted from the second server to the client. In addition, a network page enriched with online advertisement requires more memory space, both on the transmitting second server and on the receiving client. Finally, the client or the browser thereof requires a relatively long time to process the received volume of data and to output the relevant network page.

Particularly if the second server is in the form of a search engine, the information that is produced by the search engine on the basis of a search term transmitted from the client to the server includes a list of references to network pages (hits list) that are made available by other services. In order to increase the relevance of the information and references made available by a search engine in response to a query, it is known practice for this information and these references and also the search terms to be classified by methods of computer linguistics and for these classes to be associated with one another. With an association of classified search terms and information, the search engine uses a search term received from a client to select suitable information and references.

The number of queries to which a server can respond per unit time is dependent on the volume of data on the network pages that are transmitted per query from the server to the querying client, among other things. By way of example, static network pages need to be read by the server from a memory. In order to produce dynamic network pages, the respective content (information) needs to be read from at least one memory and integrated into the network page. It is conceivable for the information to be read from a plurality of memories distributed over the communication network. The network pages are then edited on the basis of the layers of a network protocol (for example, TCP/IP) used for the data transmission. Thus, the larger the volume of data to be transmitted by a server for a query, the lower the performance capability of the server that is available for further, near-time query.

The network pages are transmitted from the server to the client via the communication network. In this case, the volume of data that can be transmitted by the communication network per unit time (bandwidth) is limited.

The client initially edits a received network page on the basis of the network protocol used and then stores the network page in a suitable memory area. The browser then edits the network page such that the information can be presented on a monitor.

In order to tax the computation power and the memory capacities of the server and the client as little as possible and in order to relieve the load on the communication network by transmitting as small a volume of data as possible, it is desirable for the network page produced by the search engine to be used to present only such online advertisement as is actually of interest to the client or the user and as results in an increase in turnover on the first server.

### SUMMARY OF THE INVENTION

By reducing the volume of data on a network page, in order to tax the computation power of a server and of the client (and also the transmission power of the communication network) as little as possible and to make efficient use thereof, it is therefore an object of the invention to provide a way of using a network page of a second server to present largely only such online advertisement associated with a first server as is also of interest to a client or user or as results in an increase in turnover on the first server. The online advertisement is associated with the first server, for example by virtue of the first server or an online shop that operates the first server, or else a product that is provided or marketed by the first server or a corresponding service on the first server, being advertised by the online advertisement.

The object is achieved by virtue of: a server that is connected to the communication network automatically scanning a broadcast radio program running on at least one station; the server automatically evaluating the broadcast radio program for the purpose of recognizing the content; and the server optimizing the online advertisement according to a particular algorithm on the basis of the result of the evaluation of the broadcast radio program.

The broadcast radio program may be in the form of a radio program, in the form of a podcast, or in the form of any other audio and/or video program that can be received by a limited or unlimited number of users. In this case, the users can receive the broadcast radio program without restriction, or as subscribers. Transmission of the broadcast radio program by cable, by terrestrial radio, by satellite radio, by the Internet, or in any other way, is conceivable. It is particularly preferred if the broadcast radio program is a television program with a combination of audio and video contents.

If the broadcast radio program is in the form of a television program, the server can recognize the content of the television program by scanning the content of subtitles for deaf viewers that are transmitted together with the television program and comparing it with keywords that are stored together with these associated television program contents in a database, and in the event of a match it is assumed that the content of the scanned television program corresponds to the television program content from the database for which a match in the keywords has been established. In this way, it is possible to recognize not only the advertising broadcast via the television program but also specifically keywords, for example in news or entertainment transmissions, and to optimize the online advertisement on the basis of the keywords. In that case, it is possible to measure whether these keywords have an effect (particularly in the sense of increasing turnover) on products, services or online shops advertised via the online advertisement.

According to an advantageous development of the invention, it is proposed that the server recognizes the content of the broadcast radio program by comparing the scanned broadcast radio program or a digital fingerprint of the audio and/or video contents of the scanned broadcast radio program with broadcast radio program contents stored in a database or the fingerprint of the broadcast radio program contents, and in the event of a match it is assumed that the content of the scanned broadcast radio program corresponds to the broadcast radio program content from the database with which a match has been established. Such a method for recognizing the content of an audio and/or video program is described in detail in U.S. Pat. No. 7,853,664—but for a different purpose than in the case of the present invention. Express reference is made to this document in relation to the implementation of the step for recognizing the content of the broadcast radio program. For this purpose, the cited document is included in the content of the present application as reference.

According to one embodiment of the present invention, it is proposed that the database stores additional information for the respective program contents, which information can likewise be used for optimizing the online advertisement. The information additionally stored in the database may be the following: details relating to an advertised product; details relating to the purchaser of an advertising block; details about a target group for the broadcast radio program content; and/or details relating to a regional reach of the broadcast radio program.

Advantageously, the server: evaluates the scanned broadcast radio program for the purpose of recognizing advertising blocks; evaluates the individual advertising blocks in respect of the purchaser of the advertising block and/or the at least one advertised product for the purpose of recognizing the content of the advertising block; and optimizes the online advertisement according to a particular algorithm on the basis of the result of the evaluation of the individual advertising blocks.

According to this refinement, the broadcast radio program is thus scanned specifically for the purpose of recognizing advertising blocks. The inventor has found that use of the Internet increases during the advertising blocks. Hence, in principle, the efficiency of online advertisement that is toggled on network pages during this time increases. In addition, the inventor has found that during an advertising block the online users are particularly receptive to online advertisement for products and/or services that have been advertised previously by the advertising block. Therefore, a content of the online advertisement is chosen such that it is of particular interest to the online users. The particular receptiveness of the online users to particular advertising contents also continues for a particular time even after the end of the advertising block. It may therefore be advisable to continue to output the online advertisement on the network pages for approximately 10-30 minutes after the end of an advertising block.

The optimization of the online advertisement on the basis of the content of the broadcast radio program can be effected in different ways. In particular, the nature or type and also the content of the online advertisement, a position of the online advertisement on the network page, the network page on which the online advertisement is output, etc., can be varied so that the online advertisement is of relatively great interest to the online user and he then has a relatively high probability of purchasing the advertised product or the service from the first server. In order to vary the position of the online advertisement on a network page and/or the network page on which the online advertisement is output, the level of a maximum bid for a realtime online auction system for purchasing positions for the online advertisement on a particular network page in an auction is increased or decreased, for example. Furthermore, additional bids for online advertisement on new network pages, possibly even from a different operator than the previous network pages, on which online advertisement has been toggled can be submitted to an appropriate realtime online auction system for online advertisement.

Advantageously, the optimization of the online advertisement includes one of the following measures: ascertainment of the level of a maximum bid for the online advertisement and forwarding of the maximum bid via the communication network to the system for realtime booking of online advertisement; ascertainment of at least one network page on which the online advertisement is intended to be placed, and forwarding of the maximum bid via the communication network to the system for realtime booking of online advertisement on the ascertained network page; ascertainment of at least one time at which the online advertisement is intended to be placed, and forwarding of the maximum bid via the communication network to the system for realtime booking of online advertisement at the ascertained time; ascertainment of at least one region in which the online advertisement is intended to be presented to the online users, and forwarding of the maximum bid via the communication network to the system for realtime booking of online advertisement for the ascertained region; ascertainment of at least one search term with which the online advertisement is intended to be associated, and forwarding of the maximum bid via the communication network to the system for realtime booking of online advertisement associated with the ascertained search term; ascertainment of at least one profile of a user of the communication network to whom the online advertisement is intended to be presented, and forwarding of the maximum bid via the communication network to the system for realtime booking of online advertisement associated with the ascertained user profile; and ascertainment of at least one type of online advertisement that is intended to be displayed, and forwarding of the maximum bid via the communication network to the system for realtime booking of online advertisement of the ascertained type.

The server may book more online advertisement in the system for realtime booking of online advertisement at least at the times at which advertising blocks are recognized. In addition, it is proposed that the server books less online advertisement in the system for realtime booking of online advertisement at least at the times between the advertising blocks. Furthermore, it is proposed that the server books more of its own online advertisement in the system for realtime booking of online advertisement at least at the times at which an advertising block from a competitor is running in the broadcast radio program. Furthermore, the server books more online advertisement that fits the advertising block in terms of content in the system for realtime booking of online advertisement preferably at least at the times at which an advertising block is running in the broadcast radio program. Moreover, it is proposed that the server books less online advertisement in the system for realtime booking of online advertisement at least at the times at which bad news, catastrophes or the like are running in the broadcast radio program.

By virtue of the ascertainment of at least one profile of a user of the communication network to whom the online advertisement is intended to be presented, and the forwarding of an appropriate maximum bid via the communication network to the system for realtime booking of online advertisement associated with the ascertained user profile, it is possible to present the online advertisement only to online users for whom the online advertisement will be of particular interest because their user profile fits or even matches the user profile associated with the broadcast radio advertising or the online advertisement. By way of example, it is thus conceivable that if the broadcast radio advertising (for example a TV spot) from a particular company or for a particular product has been broadcast on the broadcast radio program, online advertisement is toggled only for such user profiles as have recently been able to be associated with particular search terms (for example, particular companies or products) or target groups.

According to another advantageous development, it is proposed that the server optimizes the online advertisement on the basis of a target group for which the scanned broadcast radio program is intended by virtue of its booking more online advertisement for products that are intended for or of interest to the target group in the system for realtime booking of online advertisement.

In addition, it is conceivable that the server optimizes the online advertisement on the basis of a regional reach of the scanned broadcast radio program by virtue of its booking more online advertisement for those online users that are within the reach of the broadcast radio program in the system for realtime booking of online advertisement.

It is also proposed that the optimization of the online advertisement has its timing limited to a prescribable period after the transmission of the broadcast radio program, for example to 10 to 30 minutes after the transmission of the broadcast radio program. Thereafter, the effect of the broadcast radio program on the receptiveness of the online users to online advertisement subsides.

In order to measure gross ranges of a station for radio/TV campaigns, the prior art reveals the use of what is known as a GRP (Gross Rating Point) value. This is used as a measure of the advertising pressure, and represents the gross reach as percentage within the target group potential. It is therefore a coarse measure for assessing a broadcast radio advertising campaign (for example a TV spot) and for the comparability of various alternatives for advertising campaigns. The GRP is particularly suited to the evaluation of TV advertising campaigns. The GRP is calculated as the net reach as a percentage multiplied by the average contacts. There is also a corresponding value (what is known as active GRP) for measuring the gross reaches of online advertisement.

It would be conceivable for both values, i.e. the GRP value and the active GRP value, to be used for the inventive method. In this way, the advertising pressure could be optimized online digitally at the moment of broadcast radio advertising, for example, in order to achieve the greatest possible gross reach for the sum total of broadcast radio advertising and online advertisement and hence to a certain extent to add to the broadcast radio advertising online. This would allow online marketers to achieve particularly large GRP. This can now be achieved within the context of the present invention by the specific online addition to the broadcast radio advertising.

At the same time, it would also be possible to use active GRP to measure the reaction (what is known as the response) of the users to broadcast radio advertising in addition to views/clicks etc. This would allow not only the GRP gross reach but also, initially, at the moment of the broadcast radio advertising, the response to the broadcast radio advertising under the influence of the online advertisement to be measured in order to find out what broadcast radio advertising should possibly be booked differently. If, in future, broadcast radio advertising (in a similar fashion to online advertisement known in the art) can be booked dynamically using RTB (Real Time Bidding) or in an auction process, it would therefore be possible, in an advantageous further development, for even broadcast radio advertising campaigns to be optimized on the basis of a digital response in future. At present (while an RTB or an auction process for broadcast radio advertising does not exist), the digital response could be at least measured and taken into account in future bookings for broadcast radio advertising.

As an extension or an alternative to the active GRP, it is also possible to apply what is known as a Delta C method for ascertaining an additional turnover or profit attained in an online shop (what is known as uplift) as a reaction to broadcast radio spots or online advertisement. In the case of the Delta C method, a reference value without uplift is compared with a value with uplift. The reference used may be single or all channels (marketing channels such as websites for particular products and services) that, according to the evaluation of the turnover or the profit, did not exhibit any uplift at the time of delivery of the broadcast radio spot. The evaluation can take place in a suitable tool at a company for optimizing online marketing (for example Hurra). The channels that exhibit an uplift can be compared against the reference value. The Delta is then the uplift that has been ascertained with a high degree of probability by virtue of the broadcast radio spot being broadcast on the television set or the radio. In this way, the background noise on the website is almost neutralized and it is possible to check whether or not the optimization of the online advertisement was actually successful.

The uplift is the measured traffic on the web page and can be ascertained by clicks or visits on the web page and the turnover attained via the web page, for example. It is likewise conceivable to ascertain the traffic from a single traffic source such as search engine advertising (SEA). The evaluation is effected using a tool that can be used to ascertain whether a greater turnover has been attained in a particular online shop during the broadcast of a television spot. An online shop or the corresponding web page frequently has some traffic, which is called background noise. In principle, the traffic is measured before the online advertisement and, by way of example, 5 minutes, 10 minutes, and 15 minutes after the online advertisement. The difference is the uplift and the impact (effect) from the advertising.

For the purpose of carrying out the inventive method, the inventive server preferably has a connection for receiving a broadcast radio program running on at least one station, and can: automatically scan the broadcast radio program; automatically evaluate the scanned broadcast radio program in order to ascertain the content of the broadcast radio program; and optimize the online advertisement according to a particular algorithm on the basis of the result of the evaluation of the broadcast radio program.

The server is preferably the first server described at the outset, which is associated with an online shop, for example, or the cited further server, which is associated with a service provider, for example a company for optimizing online marketing. The server is used to evaluate the broadcast radio program and to take the decision as to how the online advertisement can be optimized in view of the content of the broadcast radio program. Moreover, the server prompts the implementation of the optimization by virtue of maximum bids for online advertisement being stipulated and transmitted to the relevant systems for realtime booking of online advertisement. The server advantageously can carry out the inventive method, such as via a computer program that runs on at least one microprocessor of the server.

Moreover, the invention also relates to a computer program that is provided to run on a microprocessor of a server equipped with a connection for receiving a broadcast radio program running on at least one station and is programmed to carry out the inventive method when it runs on the microprocessor of the server.

### BRIEF DESCRIPTION OF THE DRAWINGS

Other objects, features, and advantages of the present invention will be readily appreciated as the same becomes better understood after reading the subsequent description taken in connection with the accompanying drawing wherein:

FIG. 1 shows a computer system according to one embodiment for carrying out an inventive method.

FIG. 2 shows a computer system according to another embodiment for carrying out an inventive method.

FIG. 3 shows a flowchart of an inventive method according to one embodiment.

FIG. 4 shows another flowchart of an inventive method according to one embodiment.

### DETAILED DESCRIPTION OF THE INVENTION

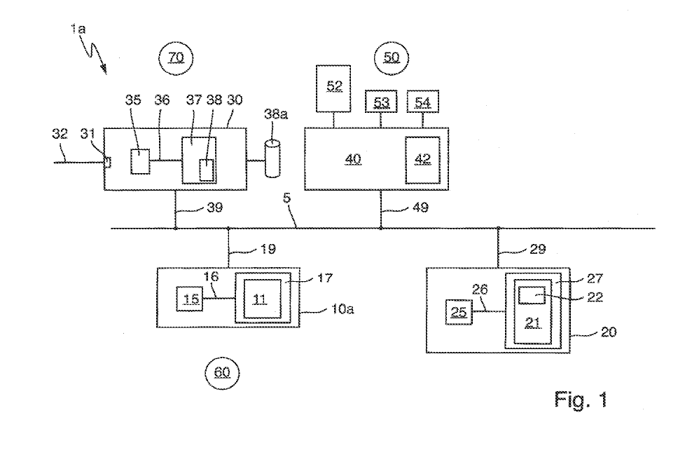

Referring now to the drawings, FIG. 1 shows a computer system 1a. A first server 10a has a processor 15 and a memory element 17 that is connected to the processor 15 via a bus system 16. The memory element 17 stores a first network page 11. A data line 19 connects the first server 10a to a communication network, for example the Internet 5. By way of example, the network page 11 is a website that can be loaded via the Internet 5 from other computers connected to the Internet 5, such as the client 40, and displayed on a screen connected to the computer.

A second server 20 likewise has a processor 25 and a memory element 27 connected to the processor 25 via a bus system 26. The memory element 27 stores a second network page 21 that has online advertisement 22. The second network page 21 may likewise be a website that can be loaded via the Internet 5 from other computers connected to the Internet 5, such as the client 40, and displayed on a screen connected to the computer. By way of example, the online advertisement 22 is an advertising banner that is presented on the website 21. In the exemplary embodiment shown, the online advertisement includes a reference, also called a “link”. The reference as part of the online advertisement 22 refers to the first network page 11, for example. The second server 20 is likewise connected to the Internet 5 via a data line 29.

A third server 30 has a processor 35 and a memory element 37 that is connected to the processor 35 via a bus system 36. The memory element 37 stores a computer program 38. By way of example, the computer program 38 provides the functionality of the inventive server by carrying out the inventive method when it runs on the processor 35. The third server 30 is likewise connected to the Internet 5 via a data line 39. Furthermore, the third server 30 has a connection 31 for receiving a broadcast radio program running on at least one station. In the exemplary embodiment shown, the third server 30 receives the broadcast radio program via a line 32, for example the digital video broadcasting cable (DVB-C). Alternatively, the connection 31 of the third server 30 may also be configured such that it can receive the broadcast radio program via a terrestrial radio link, for example digital video broadcasting terrestrial (DVB-T), or via a satellite radio link, for example digital video broadcasting satellite (DVB-S). It is also conceivable for the broadcast radio program to be received via the Internet 5 within the context of what is known as “streaming”. By way of example, the broadcast radio program may be a radio program or a television program, and a radio program could be broadcast via a digital audio broadcasting (DAB) link by terrestrial radio, by cable or by satellite radio. The third server 30 may receive a plurality of broadcast radio programs from various stations at the same time. FIG. 1 also shows a user 70, such as the operator of the third server 30 or any other person.

A data line 49 connects a client 40 to the Internet 5. By way of example, the client 40 may be in the form of a PC (personal computer) on which a browser runs. In addition, the client 40 has an associated monitor 52, keyboard 53, and mouse 54 that allow a user 50 to interact with the client 40. It is conceivable for the client 40 to be in the form of what is known as a set top box.

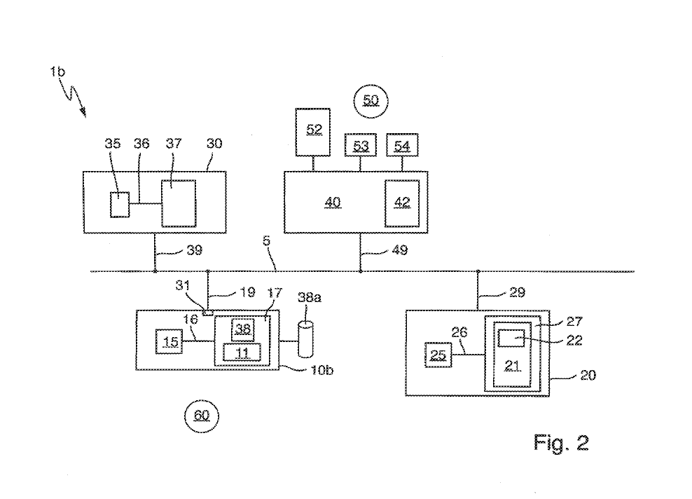

FIG. 2 shows another computer system 1b, which has a first server 10b, a second server 20, a third server 30 and a client 40. The functionality of the inventive server is again provided by the computer program 38. In the computer system 1b, however, the computer program 38 is stored in the memory element 17 of the first server 10b. Hence, in FIG. 2 the functionality of the third server 30 from FIG. 1 is thus provided within the first server 10b. FIG. 2 also shows a user 60. By way of example, the user 60 may be the operator of the first server 10b or any other person.

In addition, in FIG. 2 the connection 31 for receiving a broadcast radio program running on at least one station is arranged in the first server 10b and is in a form such that it can receive a broadcast radio program transmitted via the Internet 5 or the data line 19. In this case, the broadcast radio program may be in the form of an audio stream, a video stream or in the form of a podcast, for example. Naturally, a stream or a podcast could also be received via a suitable radio link.

The operator 60 of the first server 10a, 10b is an online shop, for example, that offers particular products and/or services for purchase on its network pages 11 via the Internet 5. The products offered do not necessarily need to be goods; it would also be conceivable for the products to be chargeable online access to a data collection or memory location on a memory 17 or an external data memory.

The second server 20 may, for example, be associated with a search engine operator that, upon a query from the client 40 based on a particular search term, creates a hits list for this search term and transmits it on its network pages 21 via the Internet 5 to the client 40. The network pages 21 of the second server 20 include not only the hits for the search term but also at least one online advertisement 22, for example in the form of an advertising banner, optionally with a reference to the first network page 11. Alternatively, the online advertisement 22 may be formed by one of the hits for the search term that is part of the hits list (what are known as “sponsored links”). By selling positions for online advertisement 22 on its network pages 21 or in the hits list, the operator of the second server 20 earns money. The online advertisement 22 is booked with the second server 20 either by the third server 30 (see FIG. 1) or by the first server 10b (see FIG. 2). It is also conceivable for the online advertisement 22 to be booked by a server connected to the Internet 5 other than the servers 10b, 30.

The operator 70 of the third server 30 may, for example, be a company for optimizing online marketing. In this case, in the example from FIG. 1, the online shop with which the first server 10a, 10b is associated could be a customer of the operator 70. The operator 70 has usually been provided with a particular budget allocated by the online shop, which the operator 70 may use to place online advertisement for the online shop and/or its products or services. In the exemplary embodiment from FIG. 2, the online shop manages its budget for online marketing itself without resorting to the services of an external company for optimizing online marketing.

The booking of online advertisement 22 is usually effected online, that is to say via the Internet 5. This may be a normal purchase of advertising space on a network page of an arbitrary operator, for example by virtue of a defined price being paid for the presentation of a particular online advertisement 22 for a particular period on a particular network page. Alternatively, it is also possible for advertising space on network pages to be purchased within the context of an online auction. In this case, a maximum bid is usually submitted for the presentation of a particular online advertisement 22 for a particular period on a particular network page. Advantageously, the online auction operates in real time or quasi real time.

Thus, following a query by the client 40 based on a particular search term, the second server 20 not only compiles the relevant hits list but also, at the same time, auctions advertising space on its network page 21 for online advertisement 22. In this case, the second server 20 evaluates the bids it has available from interested advertising parties for the advertising space that is to be allocated. Usually, the interested party that has submitted the highest bid is provided with a particularly good position for its online advertisement 22 on the network page 21 or in the hits list (because it is immediately conspicuous to the user 50). As the level of the bids decreases, further, less good positions on the network page 21 or in the hits list are then allocated if they exist. Finally, the hits list is transmitted, together with the online advertisements 22 that have received the acceptance, as a dynamic network page 21 via the Internet 5 to the client 40 that started the query. This all takes place within an extremely short time (for example a few milliseconds) and without being noticed by the user 50.

It will be appreciated that the auctioning of the advertising space on the network pages 21 can also be effected outside the second server 2, for example on a further server connected to the Internet 5. Following the auctioning of the advertising space, this further server then merely transmits information about the interested parties that have received the acceptance, or about the relevant online advertisement 22 that is to be presented on the network page 21.

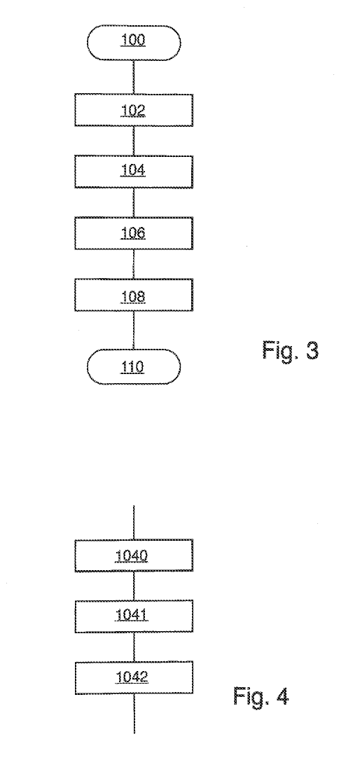

An example of a sequence for the inventive method is shown in FIG. 3. In this case, the following scenario can expediently be assumed: the user 60, for example an online shop, operates the first server 10b, which the user 50 can use to request and purchase products or services. The second server 20 provides a network page 21 for retrieval, which network page contains the online advertisement 22 with a reference to the first network page 11. By way of example, this second network page 21 may be a shopping portal that presents the online advertisement 22 on the basis of a desired service or a particular sector. Naturally, the second network page 21 may for its part be reachable via further references to further network pages.

The method starts in a step 100. In a step 102, the user 50 uses the client 50 to request the second network page 21 from the second server 20. This can be accomplished by the direct input of a URL associated with the second network page 21, for example, or else by transmitting a search query based on a particular search term to the second server 20.

In a step 104, the second server 20 prompts the content of the second network page 21 to be compiled. In particular, this involves the advertising space on the network page 21 being auctioned or sold in another way and the online advertisement 22 to be presented on the network page 21 being ascertained. In the course of this, the online advertisement 22 is also optimized by virtue of the server 30 (in the exemplary embodiment from FIG. 1) or the server 10b (in the exemplary embodiment from FIG. 2) submitting a maximum bid for the auction or stipulating a purchase price, for example. The actual information (for example a hits list) and the online advertisement 22 to be presented are then compiled dynamically for the network page 21. This step is explained in even more detail below.

In a step 106, of the dynamic network page 21 is then transmitted via the Internet 5 to the client 40. In a step 108, the second network page 21 is interpreted by the browser 42 and displayed to the user 50 via the monitor 52. The second network page 21 presents not only the actual information (for example a hits list) but also the online advertisement 22. The online advertisement 22 may have further associated textual or graphical information that describes a product and/or presents it graphically, for example. In a step 110, the method is then at an end.

Step 104 is explained in greater detail below with reference to FIG. 4. In the example from FIG. 1, the step is executed by the third server 30, and in the example from FIG. 2, it is executed by the first server 10b by virtue of the computer program 38 being executed on the processor 35 or 15. In a substep 1040, the broadcast radio program running on at least one station is scanned. In this context, “scanned” means that the entire audio and/or video content of the broadcast radio program or just a particular portion thereof is recorded. When evaluating video contents, it may suffice, for example, when searching for particular advertising logos or the like, to scan only particular regions of the screen content where advertising logos are usually presented. In a substep 1041, the scanned broadcast radio program is then automatically evaluated for the purpose of recognizing the content of the broadcast radio program. To this end, it is conceivable for the server 30 or 10b to compare the scanned broadcast radio program or a digital fingerprint of the audio and/or video contents of the scanned broadcast radio program with broadcast radio program contents stored in a database 38a, or the fingerprint of the broadcast radio program contents. In the event of a match, it is assumed that the content of the scanned broadcast radio program corresponds to the broadcast radio program content from the database 38a with which a match has been established. It is possible to refer to a match if particular characteristic features of the audio and/or video signal for the scanned broadcast radio program content at least partially match the corresponding characteristic features for the stored broadcast radio program content. FIGS. 1 and 2 show the database 38a as an external database of the server 30; 10b. Naturally, it may also be an internal database that is part of the server 30; 10b. In particular, the broadcast radio program is evaluated for the purpose of recognizing advertising blocks in the scanned broadcast radio program. In addition, the evaluation may also involve the duration, the magnitude and/or the frequency of display of an advertising logo being ascertained. The optimization of the online advertisement 22 can then be provided on the basis of the duration, the magnitude and/or the frequency of display of the advertising logo. The evaluation of the broadcast radio program is preferably effected fully automatically by an appropriate computer program, for example the computer program 38. The latter processes the incoming audio and/or video signals for the broadcast radio program received from the server 30; 10b. The processing includes audio and/or video analysis for the purpose of ascertaining the content of the broadcast radio program. From the result of the analysis, it is possible to ascertain the content of the broadcast radio program. The content is then associated with a particular advertiser, a particular advertised product or the like using information stored in the database. This information can then be used to optimize the online advertisement 22.

Following the evaluation of the broadcast radio program, the online advertisement 22 is optimized in a substep 1042 according to a particular algorithm on the basis of the result of the evaluation. To this end, it is also possible to use methods from artificial intelligence. In connection with the optimization of the online advertisement 22, it is conceivable for the database 38a to store additional information, which can likewise be used for optimizing the online advertisement, for the respective program contents. In particular, it is proposed that details relating to a product advertised in an advertising block, details relating to a purchaser of an advertising block, details relating to a target group for the broadcast radio program content and/or details relating to a regional reach of the broadcast radio program are stored in the database 38a and associated with the respective program contents.

The optimization of the online advertisement 22 may include a large number of options. In particular, the intention is for the server 30; 10b: to book more online advertisement 22 in a system for realtime booking of online advertisement 22 at least at the times at which advertising blocks are recognized in the scanned and evaluated broadcast radio program; to book less online advertisement 22 in the system for realtime booking of online advertisement 22 at least at the times between the advertising blocks of the broadcast radio program; to book more online advertisement 22 of its own for the first server 10a, 10b and/or the products provided by the latter in the system for realtime booking of online advertisement 22 at least at the times at which an advertising block from a competitor is running in the broadcast radio program; to book more online advertisement 22 that fits the advertising block in terms of content in the system for realtime booking of online advertisement 22 at least at the times at which an advertising block is running in the broadcast radio program; to book less online advertisement 22 in the system for realtime booking of online advertisement 22 at least at the times at which bad news, catastrophes or the like are running in the broadcast radio program; to optimize the online advertisement 22 on the basis of a target group for which the scanned broadcast radio program is intended by virtue of its booking more online advertisement 22 for products that are intended for the target group in the system for realtime booking of online advertisement 22; and/or to optimize the online advertisement 22 on the basis of a regional reach of the scanned broadcast radio program by virtue of its booking more online advertisement 22 for those online users 50 that are situated within reach of the broadcast radio program in the system for realtime booking of online advertisement 22. This list is not conclusive, however, and can be extended by any other, for example heuristically ascertained, rules and optimization algorithms. The optimization of the online advertisement 22 can be effected in arbitrary fashion; what is crucial is that the optimization of the advertisement is effected on the basis of the content of an observed broadcast radio program. An essence of the broadcast radio program is that it is broadcast for an indeterminate and unlimited number of recipients and can be received and output by any recipients that are within reach. By way of example, a broadcast radio program is a film, a television transmission, a radio transmission, a sport transmission, etc., that can be interrupted by one or more advertising blocks. Regardless of the type of broadcast radio program (audio or video) and regardless of the type of transmission (by cable, radio, satellite or Internet), the broadcast radio program will have its audio content and/or video content evaluated. The aim in this case is, by way of example, to detect advertising blocks in the broadcast radio program and to optimize the online advertisement 22 on the basis of the detected contents of the advertising blocks. The detection of other contents and optimization of the online advertisement 22 on the basis thereof are also conceivable.

The optimization of the online advertisement 22 can have its timing limited to a prescribable period after the transmission of the broadcast radio program. In particular, the aforementioned measures for optimization or other optimization measures are limited to approximately 10 to 20 minutes after the transmission of a relevant advertising block. Naturally, it is conceivable for optimization measures for different, successively transmitted advertising blocks to overlap.

Within the context of the invention, reference is made to online advertisement 22 that fits an advertising block in terms of content when the online advertisement 22 is for a product that belongs to the same or a similar product group as/to the product advertised in the advertising block. Examples of product groups are electrical items, photographic items, kitchen items, leisure items, etc. The product groups can also be broken down further to an arbitrarily fine degree in order to be able to identify online advertisement 22 that fits as well as possible in terms of content. Thus, by way of example, an electrical items product group can also be divided into computers, computer accessories, kitchen appliances and household appliances subgroups. The computer subgroup could in turn be divided into servers, desktop computers, laptop computers, tablet PCs and handheld devices. Alternatively, a fitting online advertisement 22 may also relate to a product that usefully adds to the product advertised in the advertising block (for example online advertisement 22 for golf vacation fitting advertising block for golf equipment).

Booking more online advertisement 22 in the system for realtime booking of online advertisement 22 means increasing the bid price or a maximum bid for the online advertisement 22 in order to have a higher probability of obtaining the acceptance for a sale or an auction of an online advertisement space on the network page 21. Alternatively, it can mean submitting price bids for the purchase of online advertisement space or maximum bids for the auction purchase of advertising space on additional network pages or in association with other search terms or sending them to additional systems for realtime booking of online advertisement 22. This allows the quality of online advertisement 22 to be specifically increased on a temporary basis. The invention does not simply involve aimless toggling of an online advertisement 22, but rather the content and placement of the online advertisement 22 is optimized such that the online advertisement is probably of great interest to the user 50 and the user 50 therefore also purchases the advertised product from the online shop or caters for turnover (high conversion rate) in another way (for example by taking out an agreement).

The optimization of the online advertisement preferably includes one of the following measures: ascertainment of the level of a maximum bid for the online advertisement 22 and forwarding of the maximum bid via the communication network 5 to the system for realtime booking of online advertisement; ascertainment of at least one network page 21 on which the online advertisement 22 is intended to be placed, and forwarding of the maximum bid via the communication network 5 to the system for realtime booking of online advertisement 22 on the ascertained network page 21; ascertainment of at least one time at which the online advertisement 22 is intended to be placed, and forwarding of the maximum bid via the communication network 5 to the system for realtime booking of online advertisement 22 at the ascertained time; ascertainment of at least one region in which the online advertisement 22 is intended to be presented to the online users 50, and forwarding of the maximum bid via the communication network 5 to the system for realtime booking of online advertisement 22 for the ascertained region; ascertainment of at least one search term (known as a keyword) with which the online advertisement 22 is intended to be associated, and forwarding of the maximum bid via the communication network 5 to the system for realtime booking of online advertisement 22 associated with the ascertained search term; and ascertainment of at least one type of online advertisement 22 that is intended to be displayed, and forwarding of the maximum bid via the communication network 5 to the system for realtime booking of online advertisement 22 of the ascertained type.

By way of example, the online advertisement 22 may include the following different types of advertisement: e-mail advertisement; banner advertisement; integrated advertising banner, such as skyscraper, content ad, rectangle; pixel banner; pop-up or pop-under advertisement; verbal placement; targeting; search engine optimization; interstitials; prestitials; in-text advertisement; site branding; web sponsoring; and commercial video clips.

In particular, it is proposed that the server 30, 10b evaluates, in substep 1041, the individual advertising blocks in respect of the purchaser of the advertising block (for example advertisement from Armani® or H&M®) and/or the at least one advertised product (for example advertisement for clothing or shoes) for the purchase of recognizing the content of the advertising block. In substep 1042, the server 30, 10b then optimizes the online advertisement 22 according to one of the algorithms cited above by way of example or according to any other algorithm on the basis of the result of the evaluation in step 1401.

Following substep 1042, the online advertisement 22 is then transmitted in optimized form to the client 40 via the communication network 5 in step 106 as already described above in order to be output to the user 50 in step 108.

Hence, two different methods take place in parallel with one another. One method relates to the constant calling of network pages 21 by a large number of users 50 using the clients 40 thereof and to the output of the called network pages 21 (with the online advertisement 22) to the users 50. At the same time, unnoticed by the users 50, the inventive optimization method is taking place in the background, according to which optimization method the online advertisement 22 presented on the called network pages 21 is optimized on the basis of the content of an observed broadcast radio program.

It is conceivable for the optimization of the online advertisement 22 to be effected not only on the basis of the content of the observed broadcast radio program but also on the basis of further information, for example about the users 50, the surf behavior thereof on the Internet 5, about the time of day, about the season, about the advertised product (for example the availability thereof or the product group thereof), etc. For this purpose, appropriate information can be downloaded from further servers on the Internet 5, for example from what is known as an advertisement server (ad server), via the Internet 5 and also processed in the server 30, 10b during the optimization of the online advertisement 22.

Information regarding the products and product groups can also be made available by an inventory control system. By way of example, inventory control systems may be information systems that are made available by a further server on the Internet 5 and that, besides a large number of pieces of information regarding the products and product groups, produce, manage and provide further information, such as statistics and forecasts for these pieces of information. By way of example, inventory control systems can provide an availability for the product or a number of cancellations of orders for the product. An inventory control system may also be part of the first server 10a, 10b or the third server 30. Additional information regarding the user 50 can be stored in what is known as a cookies on the client 40, for example. The user 50 can have cookies set by the first 10a, 10b, the second 20 and/or the third 30 server. Instead of all of the additional information, a cookie may also contain just a reference to a further server on the Internet 5 where the additional information is then stored.

If a search engine (for example second server 20) is suited to finding one or more suppliers for a particular product, each supplier has an associated set of search terms and each search term in turn has one or more associated products or product groups. It is advantageous to display only such online advertisement 22 as is actually of interest to a user 50. This makes it particularly possible to minimize the volume of data on the produced network page 21 that needs to be transmitted to the client 40 via the communication network 5 so as to make the most efficient use of the available bandwidth and the computation power of the processors 35, 15 of the servers 30, 10b in this way.

In the case of the flowcharts shown in FIGS. 3 and 4 for exemplary embodiments of the inventive method, it is possible to alter or omit individual steps or to add new steps. By way of example, the user 50 can have a plurality of cookies set by the first 10a, 10b, the second 20 and/or the third 30 server. This would allow a behavior by the user 50 to be analyzed even more accurately and even more precise optimization of the online advertisement 22 presented on the second network page 21 to take place.

The invention has been described in an illustrative manner. It is to be understood that the terminology which has been used is intended to be in the nature of words of description rather than of limitation. Many modifications and variations of the invention are possible in light of the above teachings. Therefore, within the scope of the appended claims, the invention may be practiced other than as specifically described.

What is claimed is:

1. A method for optimizing online advertisement that is booked via a communication network in a system for realtime booking of online advertisement in the communication network on a particular network page, at a particular time, in association with a particular search term and/or as a particular type of online advertisement, wherein:
a server that is connected to the communication network automatically scans a broadcast radio program running on at least one station,
the server automatically evaluates the broadcast radio program for the purpose of recognizing content, and
the server optimizes the online advertisement according to a particular algorithm on the basis of the result of the evaluation of the broadcast radio program.

2. The method as set forth in claim 1, wherein the broadcast radio program is a television program.

3. The method as set forth in claim 2, wherein the server recognizes the content of the television program by scanning the content of subtitles transmitted together with the television program and comparing the subtitled with keywords that are stored together with these associated television program contents in a database, and in the event of a match it is assumed that the content of the scanned television program corresponds to the television program content from the database for which a match in the keywords has been established.

4. The method as set forth in claim 1, wherein the server recognizes the content of the broadcast radio program by comparing the scanned broadcast radio program or a digital fingerprint of the audio and/or video contents of the scanned broadcast radio program with broadcast radio program contents stored in a database or the fingerprint of said broadcast radio program contents, and in the event of a match it is assumed that the content of the scanned broadcast radio program corresponds to the broadcast radio program content from the database with which a match has been established.

5. The method as set forth in claim 4, wherein the database stores additional information for the respective program contents, which information can likewise be used for optimizing the online advertisement.

6. The method as set forth in claim 5, wherein the additional information stored in the database is:
details relating to the advertised product,
details relating to the purchaser of an advertising block,
details about the target group for the broadcast radio program content, and/or
details relating to the regional reach of the broadcast radio program.

7. The method as set forth in claim 6, wherein
the server evaluates the scanned broadcast radio program for the purpose of recognizing advertising blocks,
the server evaluates the individual advertising blocks in respect of the purchaser of the advertising block and/or the at least one advertised product for the purpose of recognizing the content of the advertising block, and
the server optimizes the online advertisement according to a particular algorithm on the basis of the result of the evaluation of the individual advertising blocks.

8. The method as set forth in claim 1, wherein the optimization of the online advertisement includes one of the following measures:
ascertainment of the level of a maximum bid for the online advertisement and forwarding of the maximum bid via the communication network to the system for realtime booking of online advertisement,
ascertainment of at least one network page on which the online advertisement is intended to be placed, and forwarding of the maximum bid via the communication network to the system for realtime booking of online advertisement on the ascertained network page,
ascertainment of at least one time at which the online advertisement is intended to be placed, and forwarding of the maximum bid via the communication network to the system for realtime booking of online advertisement at the ascertainment time,
ascertained of at least one region in which the online advertisement is intended to be presented to the online users, and forwarding of the maximum bid via the communication network to the system for realtime booking of online advertisement for the ascertained region,
ascertainment of at least one search term with which the online advertisement is intended to be associated, and forwarding of the maximum bid via the communication network to the system for realtime booking of online advertisement associated with the ascertained search term,
ascertainment of at least one profile of a user of the communication network to whom the online advertisement is intended to be presented, and forwarding of the maximum bid via the communication network to the system for realtime booking of online advertisement associated with the ascertained user profile, and
ascertainment of at least one type of online advertisement that is intended to be displayed, and forwarding of the maximum bid via the communication network to the system for realtime booking of online advertisement of the ascertained type.

9. The method as set forth in claim 7, wherein the server books more online advertisement in the system for realtime booking of online advertisement at least at the times at which advertising blocks are recognized.

10. The method as set forth in claim 7, wherein the server books less online advertisement in the system for realtime booking of online advertisement at least at the times between the advertising blocks.

11. The method as set forth in claim 7, wherein the server books more of its own online advertisement in the system for realtime booking of online advertisement at least at the times at which an advertising block from a competitor is running in the broadcast radio program.

12. The method as set forth in claim 9, wherein the server books more online advertisement that fits the advertising block in terms of content in the system for realtime booking of online advertisement at least at the times at which an advertising block is running in the broadcast radio program.

13. The method as set forth in claim 10, wherein the server books less online advertisement in the system for realtime booking of online advertisement at least at the times at which bad news, catastrophes or the like are running in the broadcast radio program.

14. The method as set forth in claim 6, wherein the server optimizes the online advertisement on the basis of a target group for which the scanned broadcast radio program is intended by virtue of its booking more online advertisement for products that are intended for the target group in the system for realtime booking of online advertisement.

15. The method as set forth in claim 6, wherein the server optimizes the online advertisement on the basis of a regional reach of the scanned broadcast radio program by virtue of its booking more online advertisement for those online users that are within the reach of the broadcast radio program in the system for realtime booking of online advertisement.

16. The method as set forth in claim 6, wherein the optimization of the online advertisement has its timing limited to a prescribable period after the transmission of the broadcast radio program.

17. The method as set forth in claim 1, wherein the communication network is the Internet or another local area network.

18. A server that is connected to a communication network for the purpose of optimizing online advertisement, wherein the server books online advertisement in the communication network on a particular network page, at a particular time, in association with a particular search term and/or as a particular type of online advertisement via the communication network in a system for realtime booking of online advertisement, wherein the server:
has a connection for receiving a broadcast radio program running on at least one station, and
a computer program that is programmed to execute the inventive method as set forth in claim 1 runs on a microprocessor of the server.

19. A computer program that is provided to run on a microprocessor of a server connected to a communication network and is programmed for optimizing online advertisement that is booked via the communication network in a system for realtime booking of online advertisement in the communication network on a particular network page, at a particular time, in association with a particular search term and/or as a particular type of online advertisement, wherein the computer program is provided to run on a microprocessor of a server equipped with a connection for receiving a broadcast radio program running on at least one station and is programmed to execute the method as set forth in claim 1 when it runs on the microprocessor of the server.
